(19) United States
(12) Patent Application Publication
(10) Pub. No.: US 2010/0126654 A1
(43) Pub. Date: May 27, 2010

(54) WORKING APPARATUS, APPARATUS FOR APPLYING ADHESIVE TAPE, AND TAPE MEMBER ADDING METHOD

(76) Inventors: Atsushi Katayama, Kyoto (JP); Hiroyuki Murata, Osaka (JP); Masayuki Ida, Osaka (JP); Kozo Odawara, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/593,664

(22) PCT Filed: Mar. 28, 2008
(86) PCT No.: PCT/JP2008/000795

§ 371 Date: Dec. 1, 2009

(30) Foreign Application Priority Data
Mar. 30, 2007 (JP) 2007-091962

(51) Int. Cl. B29C 65/50; B32B 38/04; B32B 37/02; B29C 65/30

(52) U.S. Cl. 156/159; 156/502; 156/510; 156/380.8

(57) ABSTRACT

In adhesive tape applying process for transferring, along a tape transfer path, a tape member with an adhesive tape applied on one side of a release tape, cutting the adhesive tape into a specified length, peeling the adhesive tape from the release tape, and applying the adhesive tape to a substrate, the process includes: placing a terminal end portion of an in-use first tape member and a leading end portion of a newly added second tape member in superimposition on each other in their thicknesswise direction by an apparatus for applying adhesive tape; and pressuring and heating a superposition region of end portions of the first and second tape members at least partly in a widthwise direction of the tape members to partly fuse and join together the terminal end portion of the first tape member and the leading end portion of the second tape member at their superposition regions.

### TECHNICAL FIELD

The present invention relates to a working apparatus for mounting components on an object article such as display panels typified by liquid crystal panels and PDPs (Plasma Display Panels). In particular, the invention relates to an apparatus for applying adhesive tape dedicated to fixation of mounted components. Also, the invention relates to a tape member adding method for, in such an apparatus for applying adhesive tape, joining together end portions of longitudinally continued tape members each with an adhesive tape applied thereto so as to add tape members.

### BACKGROUND ART

Conventionally, there has been known a component mounting apparatus which works for applying adhesive tape for use of mounted-component fixation to a liquid crystal panel or other display panel and then pressure bonding mounted components to the adhesive tape. One example is a component mounting apparatus which works in a way that with use of an ACF (Anisotropic Conductive Film) tape including an ACF applied to one side surface of a release tape, the ACF with release tape is applied to a liquid crystal panel, followed by separation of the release tape from the ACF, and thereafter mounted components (e.g., ICs, TCPs (Tape Carrier Packages), thin type LSI package components, etc.) are pressure bonded to the ACF, by which components are mounted onto the liquid crystal panel. In such a conventional component mounting apparatus, an ACF applying apparatus for applying of the ACF is included.

In such a conventional ACF applying apparatus, while an ACF tape wound on a reel is fed, the ACF is cut into ACF pieces of a specified length and then fed onto a substrate placed on a stage, and thereafter pressed by a head so that the ACF pieces cut into the specified length are applied onto the substrate. Along with this operation, release tape is separated off, by which ACF-piece applying operation is carried out. Such a sequence of ACF applying operations are repetitively carried out, by which ACF applying operation for a plurality of ACF applying positions on the substrate is accomplished.

In such a conventional ACF tape applying apparatus, for reduction of reel replacement frequency, a terminal end portion of an in-use adhesive tape and a leading end portion of a new-coming ACF tape are joined and connected together to fulfill continuous feed of the ACF tape.

As a method for such ACF tape connection, for example, Patent Literature 1 discloses a connection method that top and bottom of a first ACF tape in use are reversed and twisted over, and an ACF of a newly added second ACF tape and the ACF of the first adhesive tape are superimposed on each other, the ACFs being then thermo-compressed to each other so as to be joined together. Another method available is that, as shown in FIGS. 20A and 20B, a release tape 502 at a terminal end portion of an in-use ACF tape 501 and a release tape 512 at a leading end portion of a newly added ACF tape 511 are connected together by using an another-member bonding tape 509 to fulfill junction of ACF tapes.

Patent Literature 1: JP 2004-196540 A

### DISCLOSURE OF INVENTION

### Problems to be Solved by the Invention

However, as in the case of Patent Literature 1, the method involving ACF-to-ACF thermo-compression has a problem that an ACF layer comes out of the release tape, the coming-out ACF having adhesion may adhere to rollers or other members in a following tape transfer path, causing transfer trouble.

Also, with the use of a bonding tape other than the ACF tape, there is a problem that applying such bonding tape incurs complication of apparatus construction. Further, since the bonding tape is a member independent of the ACF tape, there is a further problem that a burden for management of such bonding tape is increased.

In recent years, in particular, along with increasing scale of liquid crystal panels, which are an object of ACF tape applying, the use amount of the ACF tape tends to increase. Due to this, it is desired to perform the addition of ACF tape with high efficiency in terms of productivity improvement as well.

Accordingly, an object of the present invention, lying in solving the above-described problems, is to provide an apparatus for applying adhesive tape and a tape member adding method by which, in adhesive tape applying process including steps of transferring along a tape transfer path a tape member with an adhesive tape fixedly applied to one surface of a release tape, cutting the adhesive tape into a specified length to separate the adhesive tape from the release tape and apply the adhesive tape to a substrate, it is made achievable to connect together a terminal end portion of an in-use tape member and a leading end portion of a newly added tape member with simplicity and accuracy.

### Means to Solving the Issue

In order to achieve the above object, the present invention has the following constitutions.

According to a first aspect of the present invention, there is provided a working apparatus for transferring, along a tape transfer path, a tape member formed from resin material, and working for mounting of components onto a substrate by using the tape member, the working apparatus comprising:

a stage on which a terminal end portion of an in-use first tape member and a leading end portion of a newly added second tape member are placed so as to be superimposed on each other in their thicknesswise direction; and

a tape junction device including: a projective portion which is placed so as to face the stage and which pressures a superposition region of end portions of the first and second tape members on the stage at least partly in a widthwise direction of the tape members; and an energy applying device for applying energy to the projective portion, wherein the tape junction device, while pressuring the tape members by the projective portion, applies energy to the projective portion from the energy applying device so as to heat the tape members so that the terminal end portion of the first tape member and the leading end portion of the second tape member are partly fused at their superposition regions so as to be joined together.

According to a second aspect of the present invention, there is provided an apparatus for applying adhesive tape for transferring, along a tape transfer path, a tape member with an adhesive tape applied on one side of a release tape, cutting the adhesive tape into a specified length, peeling the adhesive tape from the release tape, and applying the adhesive tape to a substrate, the apparatus for applying adhesive tape comprising:

a stage on which a terminal end portion of an in-use first tape member and a leading end portion of a newly added second tape member are placed so as to be superimposed on each other in their thicknesswise direction;

a tape junction device including: a projective portion which is placed so as to face the stage and which pressures a superposition region of end portions of the first and second tape members on the stage at least partly in a widthwise direction of the tape members; and an energy applying device for applying energy to the projective portion, wherein the tape junction device, while pressuring the tape members by the projective portion, applies energy to the projective portion from the energy applying device so as to heat the tape members so that the terminal end portion of the first tape member and the leading end portion of the second tape member are partly fused at their superposition regions so as to be joined together.

According to a third aspect of the present invention, there is provided the apparatus for applying adhesive tape as defined in the second aspect, wherein the tape junction device has, as the energy applying device, a heating unit for heating the projective portion so as to allow the terminal end portion of the first tape member and the leading end portion of the second tape member to be thermally fused and joined together.

According to a fourth aspect of the present invention, there is provided the apparatus for applying adhesive tape as defined in the third aspect, wherein the projective portion has a height larger than a thickness of the tape members.

According to a fifth aspect of the present invention, there is provided the apparatus for applying adhesive tape as defined in the third aspect, wherein the tape junction device includes a plurality of the projective portions so that the superposition region of the first and second tape members is pressed by the individual projective portions.

According to a sixth aspect of the present invention, there is provided the apparatus for applying adhesive tape as defined in the third aspect, wherein a recess portion for receiving the projective portion by an inner surface of the recess portion via the tape members is formed in the stage.

According to a seventh aspect of the present invention, there is provided the tape applying apparatus as defined in the sixth aspect, wherein the inner surface of the recess portion is formed larger than the projective portion.

According to an eighth aspect of the present invention, there is provided the tape applying apparatus as defined in the third aspect, wherein in the tape junction device, the projective portion is provided so as to make contact with a widthwise central portion of the tape members placed on the stage.

According to a ninth aspect of the present invention, there is provided the tape applying apparatus as defined in the third aspect, wherein the tape junction device includes a tool having the projective portion, and a flat portion for pressing, against the stage, a peripheral region of a press region of the tape members pressed by the projective portion to hold the superposition region of the tape members.

According to a tenth aspect of the present invention, there is provided the tape applying apparatus as defined in the third aspect, wherein the projective portion is formed of a heating wire, and the heating unit supplies electric power to the heating wire.

According to an eleventh aspect of the present invention, there is provided the tape applying apparatus as defined in the third aspect, wherein the tape junction device joins together the release tape of the first tape member and the release tape of the second tape member by thermal fusion bonding.

According to a twelfth aspect of the present invention, there is provided the apparatus for applying adhesive tape as defined in the third aspect, wherein

the tape junction device comprises:

a first holding member which is placed on a more upstream side than a junction position of the projective portion in the tape transfer path and which holds the first tape member;

a first cutting part which is placed on a more upstream side than a holding position of the first holding member in the tape transfer path and which cuts the first tape member held by the first holding member to form the terminal end portion of the first tape member;

a second holding member which is placed on a more downstream side than the junction position of the projective portion in the tape transfer path and which holds the leading end portion of the second tape member; and

a second cutting part which is placed between a holding position of the second holding member and a junction position of the projective portion in the tape transfer path and which cuts the second tape member on the downstream side of the junction position.

According to a 13th aspect of the present invention, there is provided a tape member adding method for adding a tape member to an apparatus for applying adhesive tape which works for transferring, along a tape transfer path, a tape member with an adhesive tape applied on one side of a release tape, cutting the adhesive tape into a specified length, peeling the adhesive tape from the release tape, and applying the adhesive tape to a substrate, the tape member adding method comprising:

placing a terminal end portion of an in-use first tape member and a leading end portion of a newly added second tape member in superimposition on each other in their thicknesswise direction by the apparatus for applying adhesive tape; and

pressuring and heating a superposition region of end portions of the first and second tape members at least partly in a widthwise direction of the tape members to partly fuse and join together the terminal end portion of the first tape member and the leading end portion of the second tape member at their superposition regions.

According to a 14th aspect of the present invention, there is provided the tape member adding method as defined in the 13th aspect, wherein in the junction of the tape members, the release tape in the first tape member and the release tape of the second tape member are joining together by thermal fusion bonding.

According to a 15th aspect of the present invention, there is provided the tape member adding method as defined in the 13th aspect, wherein after the adhesive tape applied to the terminal end portion of the first tape member is removed, the first and second tape members are placed so as to be superimposed on each other.

According to a 16th aspect of the present invention, there is provided the tape member adding method as defined in the 13th aspect, wherein the first tape member placed on the tape transfer path is held on a more upstream side than a junction position with the second tape member, the first tape member is cut off on a more upstream side than the holding position to form the terminal end portion, then with the second tape member fed along the tape transfer path, the leading end portion of the second tape member is held on a more downstream side than the junction position on the tape transfer path, and the terminal end portion of the first tape member and the leading end portion of the second tape member are placed at the junction position so as to be superimposed to each other in their thicknesswise direction, and

simultaneously when or after the first tape member and the second tape member are joined together at the junction position, the second tape member is cut off at a position between the junction position and the holding position of the leading end portion of the second tape member.

### Effect of the Invention

According to the present invention, a terminal end portion of an in-use first tape member and a leading end portion of a newly added second tape member are placed in superimposition on each other in their thicknesswise direction by the apparatus for applying adhesive tape, and a superposition region of end portions of the first and second tape members are pressed and heated at least partly in a widthwise direction of the tape members to partly fuse and join together a terminal end portion of the first tape member and a leading end portion of the second tape member at their superposition regions. Therefore, double-sided tape or other additional member, as would be required in conventional junction methods, are not needed for the junction, so that the management burden in the junction process can be reduced. Also, since the superposition regions of the individual tape members are partly, i.e. locally, fused in the widthwise direction, the tape members are prevented from being considerably deformed in their outer shapes due to the fusion, allowing smooth tape feed to be fulfilled after the junction. Further, such junction by fusion is performed by partly pressuring the superposition region placed on the stage with the projective portion and by heating with energy applied by the energy applying device. Therefore, the junction can be achieved with a relatively simple apparatus construction. Thus, there can be provided an apparatus for applying adhesive tape, as well as a tape member adding method, which allows a terminal end portion of an in-use tape member and a leading end portion of a newly added tape member to be connected together conveniently and accurately in adhesive tape applying process.

### BRIEF DESCRIPTION OF DRAWINGS

These aspects and features of the present invention will become clear from the following description taken in conjunction with the preferred embodiments thereof with reference to the accompanying drawings, in which:

FIG. 1 is a schematic perspective view of an ACF applying apparatus according to a first embodiment of the present invention;

FIG. 2 is a schematic plan view of the ACF applying apparatus of FIG. 1;

FIG. 3 is a schematic side view of the ACF applying apparatus of FIG. 1;

FIG. 4 is a schematic structural view of a splicing unit in the ACF applying apparatus of the first embodiment;

FIG. 5 is a schematic perspective view of a nichrome wire heating tool included in the splicing unit;

FIG. 6 is a schematic perspective view of a heating tool according to a modification of FIG. 4;

FIG. 7 is a schematic perspective view of a projective tool according to a modification of FIG. 4;

FIG. 8A is a schematic explanatory view of a splicing unit showing a mode of thermal fusion bonding by a nichrome-wire side heating tool;

FIG. 8B is a schematic explanatory view of a junction portion of ACF tapes showing a mode of thermal fusion bonding by the nichrome-wire side heating tool;

FIG. 8C is a schematic explanatory view of a junction portion of ACF tapes showing a mode of thermal fusion bonding by the nichrome-wire side heating tool;

FIG. 9 is a schematic explanatory view of a junction portion of ACF tapes showing a mode of thermal fusion bonding by a projective tool having a plurality of projective portions;

FIG. 10 is a schematic explanatory view of a junction portion of ACF tapes showing a mode of thermal fusion bonding by a projective tool having a plurality of projective portions according to a modification of FIG. 9;

FIG. 11A is a schematic explanatory view of a junction portion of ACF tapes showing a mode of thermal fusion bonding by a projective tool having a plurality of projective portions;

FIG. 11B is a schematic explanatory view of a junction portion of ACF tapes showing a mode of thermal fusion bonding by a projective tool having a plurality of projective portions;

FIG. 11C is a schematic explanatory view of a junction portion of ACF tapes showing a mode of thermal fusion bonding by a projective tool having a plurality of projective portions;

FIG. 12 is a schematic explanatory view of a junction portion of ACF tapes showing a mode of thermal fusion bonding by a projective tool having a wedge-shaped projective portion;

FIG. 13A is a schematic explanatory view showing a procedure for splicing process in the first embodiment;

FIG. 13B is a schematic explanatory view showing a procedure for splicing process in the first embodiment;

FIG. 13C is a schematic explanatory view showing a procedure for splicing process in the first embodiment;

FIG. 14 is a schematic view showing a construction of a splicing unit according to a second embodiment of the invention;

FIG. 15A is a schematic explanatory view showing a procedure for splicing process in the second embodiment;

FIG. 15B is a schematic explanatory view showing a procedure for splicing process in the second embodiment;

FIG. 15C is a schematic explanatory view showing a procedure for splicing process in the second embodiment;

FIG. 15D is a schematic explanatory view showing a procedure for splicing process in the second embodiment;

FIG. 15E is a schematic explanatory view showing a procedure for splicing process in the second embodiment;

FIG. 16 is a schematic view showing a construction of a splicing unit according to a third embodiment of the invention;

FIG. 17 is a schematic view showing a construction of a splicing unit according to a fourth embodiment of the invention;

FIG. 18A is a schematic view showing a structure of a junction portion of ACF tapes to be subjected to splicing process of the invention;

FIG. 18B is a schematic view showing a structure of a junction portion of ACF tapes to be subjected to splicing process of the invention;

FIG. 18C is a schematic view showing a structure of a junction portion of ACF tapes to be subjected to splicing process of the invention;

FIG. 18D is a schematic view showing a structure of a junction portion of ACF tapes to be subjected to splicing process of the invention;

FIG. 18E is a schematic view showing a structure of a junction portion of ACF tapes to be subjected to splicing process of a prior art;

FIG. 19 is a conceptual view of component mounting process;

FIG. 20A is a schematic explanatory view of conventional splicing process;

FIG. 20B is a schematic explanatory view of conventional splicing process;

FIG. 21 is a schematic perspective view of an ACF applying apparatus according to a fifth embodiment of the invention;

FIG. 22 is a schematic perspective view of the splicing unit of the fifth embodiment;

FIG. 23 is a schematic view showing an ACF tape feed state from a reel in the ACF applying apparatus of the fifth embodiment;

FIG. 24A is a schematic view showing a procedure for splicing process in the fifth embodiment;

FIG. 24B is a schematic view showing a procedure for splicing process in the fifth embodiment;

FIG. 24C is a schematic view showing a procedure for splicing process in the fifth embodiment;

FIG. 24D is a schematic view showing a procedure for splicing process in the fifth embodiment;

FIG. 25E is a schematic view showing a procedure for splicing process in the fifth embodiment, subsequent to FIG. 24D;

FIG. 25F is a schematic view showing a procedure for splicing process in the fifth embodiment;

FIG. 25G is a schematic view showing a procedure for splicing process in the fifth embodiment;

FIG. 25H is a schematic view showing a procedure for splicing process in the fifth embodiment;

FIG. 26I is a schematic view showing a procedure for splicing process in the fifth embodiment, subsequent to FIG. 25H;

FIG. 26J is a schematic view showing a procedure for splicing process in the fifth embodiment;

FIG. 26K is a schematic view showing a procedure for splicing process in the fifth embodiment;

FIG. 27 is a schematic view showing a joined state of a first ACF tape and a second ACF tape in the splicing process of the fifth embodiment;

FIG. 28L is a schematic view showing a procedure for an edge processing step in the splicing process of the fifth embodiment, subsequent to FIG. 26K;

FIG. 28M is a schematic view showing a procedure for the edge processing step in the splicing process of the fifth embodiment; and

FIG. 28N is a schematic view showing a procedure for the edge processing step in the splicing process of the fifth embodiment.

### BEST MODE FOR CARRYING OUT THE INVENTION

Before the description of the present invention proceeds, it is to be noted that like parts are designated by like reference numerals throughout the accompanying drawings.

Hereinbelow, embodiments according to the present invention will be described in detail with reference to the accompanying drawings.

### FIRST EMBODIMENT

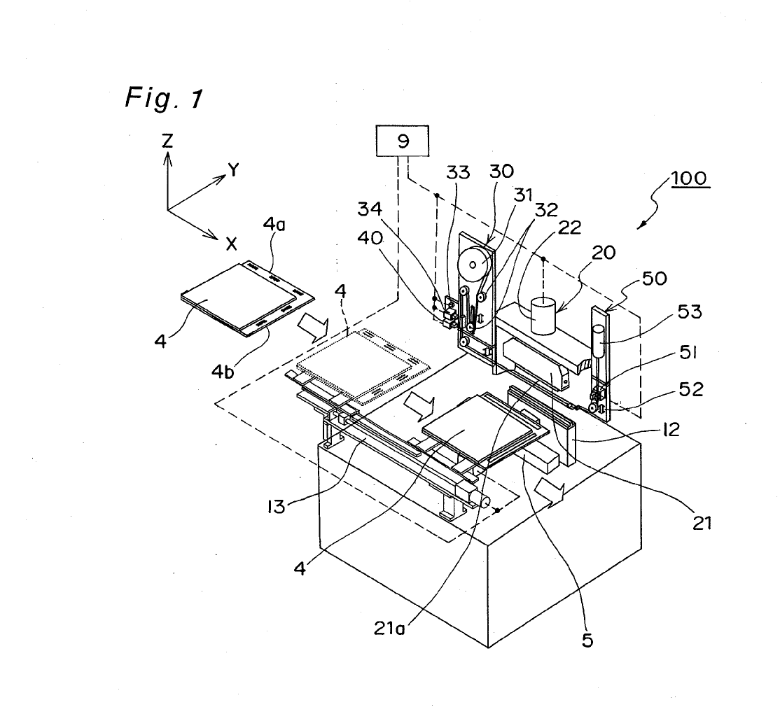

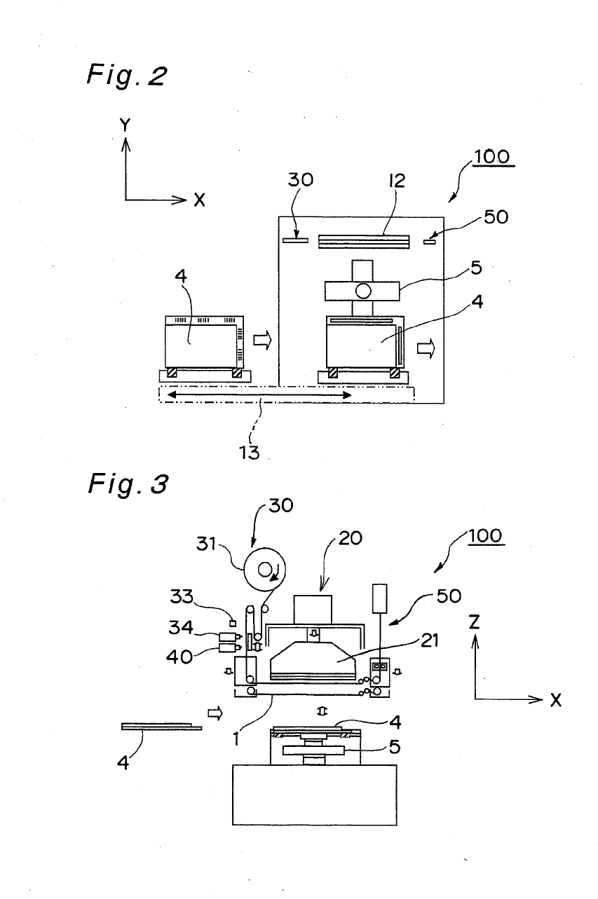

FIG. 1 shows a schematic perspective view showing a construction of an ACF applying apparatus 100 as an example of an apparatus for applying adhesive tape with a release tape according to a first embodiment of the invention. FIG. 2 shows a schematic plan view of the ACF applying apparatus 100, and FIG. 3 shows a schematic side view thereof. The ACF applying apparatus 100 shown in FIGS. 1 to 3 is so designed that with use of ACF tape (tape member) having an ACF (anisotropic conductive film) as an example of adhesive tape applied on one surface of a release tape, the ACF is applied onto a liquid crystal panel substrate (hereinafter, referred to as “panel substrate”), which is a applying object, and then the release tape of the ACF is separated off so as to allow components to be mounted onto the panel via the applied ACF. It is noted that although this embodiment is explained by taking an ACF containing anisotropic conductive particles as an example of the adhesive tape, tapes containing no anisotropic conductive particles (i.e., tapes having no conducting function and having bonding function) may also be used as such adhesive tape.

The ACF applying apparatus 100 shown in FIGS. 1 to 3 includes: a substrate holding stage 5 for receiving and holding a panel substrate 4 and moreover performing X-axial and Y-axial horizontal movement and Z-axial up/down movement of the held panel substrate 4 as viewed in the figures as well as its θ-rotational movement in an X-Y plane; a substrate transfer device 13 for, while supporting from its lower surface side, transferring the panel substrate 4, which has been carried in to a carry-in position in the ACF applying apparatus 100, in the X-axis direction in the figures so as to transfer the panel substrate 4 onto the substrate holding stage 5; and a pressure-bonding head unit 20 which is so placed as to face an end-portion placement stage 12 serving as a base on which an end portion of the panel substrate 4 held on the panel holding stage 5 is to be placed. Also, on the end-portion placement stage 12, a terminal portion that is an area for component placement in the liquid crystal panel substrate 4, which is an applying object, can be placed. In addition, in the liquid crystal panel substrate 4, its longer-edge side terminal portion is a source-side terminal portion 4a while its shorter-edge side is a gate-side terminal portion 4b, where a plurality of ACF applying positions to apply the ACF for component placement are set at the individual terminal portions 4a, 4b.

With the pressure bonding unit 20 interposed, on the left side in the figure is an ACF feed unit 30 for feeding ACF tapes wound on a reel to between the pressure bonding unit 20 and the end-portion placement stage 12, while on the right side in the figure is a release tape collection unit 50 for collecting a release tape from which the ACF has been separated.

As shown in FIGS. 1 and 3, the pressure-bonding head unit 20 has, at its lower surface, a pressure bonding surface 21a facing the end-portion placement stage 12 placed below, and further has a head 21 as an example of a tape applying head for performing ACF applying operation, and a head up/down device 22 for moving the head 21 up and down. The head 21 is internally equipped with an unshown heating means, thus being enabled to heat the pressure bonding surface 21a of the head 21 to a specified temperature.

The ACF feed unit 30 includes: a reel 31 with ACF tape wound on; a plurality of rollers 32 for guiding the ACF fed from the reel 31; a terminal-end detection sensor 33 as an example of detection means for detecting an edge, i.e. terminal end, of an ACF tape; and a cutter 34 as an example of a tape cutting portion for forming cutouts in a continued ACF applied to the release tape so as to give ACF pieces of a specified length corresponding to a size of a component mounting area in the panel substrate 4. In addition, the terminal-end position detection sensor 33, although so designed as to detect a terminal end portion of the ACF tape, may also be designed so as to detect a tape connecting portion of a tape in such a case where the tape preliminarily has a tape splicing portion, i.e. a tape connecting portion.

The release tape collection unit 50 includes: a feed chuck 51 (tape feed section) which is moved above the end-portion placement stage 12 while releasably grasping the release tape with the ACF separated therefrom so as to fulfill ACF tape feed operation from the reel 31 as well as release tape feed discharge operation from above the end-portion placement stage 12; and a roller 52 for guiding a destination of the release tape fed and discharged by the feed chuck 51, and a tape collecting section 53 for collection of the release tape.

The ACF applying apparatus 100 having such a construction as described above is provided with a control unit 9 for controlling the above-described component members and sections in association thereamong. More concretely, the control unit 9 is enabled to exert control of ACF tape feeding operation and release tape collecting operation by the ACF feed unit 30 and the release tape collection unit 50, respectively, control of ACF applying operation (including heating operation) by the pressure-bonding head unit 20, and control of ACF cutting operation by the cutter 34.

Next, with regard to the ACF applying apparatus 100 having the construction described above, below described is the construction for performing the splicing process, which is a process of performing tape connection by joining together a terminal end portion of an in-use ACF tape and a leading end portion of a new ACF tape.

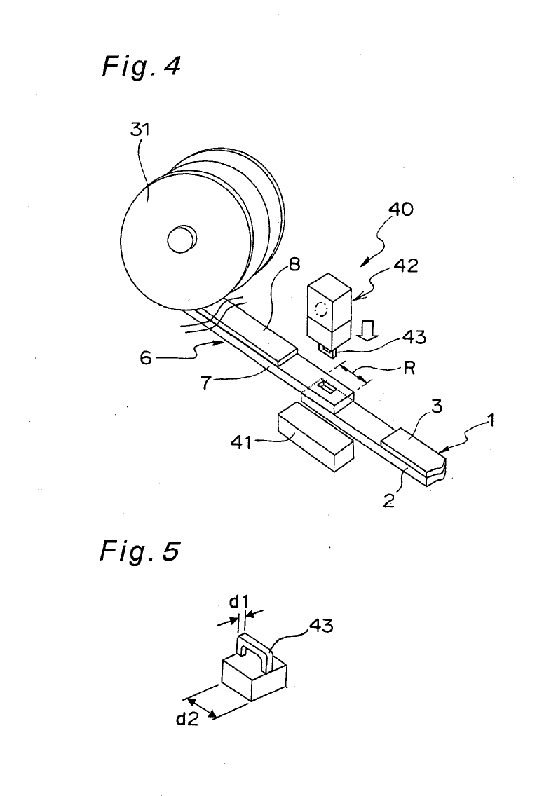

As shown in the schematic perspective view of FIG. 1, on a tape-transfer-path downstream side of the terminal-end detection sensor 33 and the cutter 34 in the ACF feed unit 30 is provided a splicing unit 40 which is an example of a tape member junction device for joining together ACF tapes. A construction of the splicing unit 40 is shown in the schematic explanatory view of FIG. 4. As shown in FIG. 4, the splicing unit 40 includes: a stage 41 on which the terminal end portion of an in-use first ACF tape 1 and the leading end portion of a newly added second ACF tape 6 are set so as to be superimposed on each other in their thicknesswise direction; and a heating unit 42 which is placed opposite the stage 41 and which, while partly pressuring, heating a superposition region R of the first ACF tape 1 and the second ACF tape 6 placed on the stage 41. The heating unit 42 includes a nichrome wire heating tool 43 (see FIG. 5) which has a projective-shaped forward end portion for partly pressuring the superposition region R of the ACF tapes and which performs heating. In addition, although not shown, a power supply means which supplies electric power for heating to the nichrome wire heating tool 43 is provided.

As shown in FIG. 4, the first ACF tape 1 has a structure that an ACF 3 is applied on an upper surface of a release tape 2 as viewed in the figure. The state shown in FIG. 4 is that the terminal end portion of the ACF 3 has been removed from the release tape 2. Similarly, the second ACF tape 6 has a structure that an ACF 8 is applied on the upper surface of a release tape 7 as viewed in the figure, and the state shown in FIG. 4 is that the leading end portion of the ACF 8 has been removed from the release tape 7. The release tape 2 at the terminal end portion of the first ACF tape 1 and the release tape 7 at the leading end portion of the second ACF tape 6 of the above-described structure are superimposed on each other and placed on the stage 41 as such, where part of their superposition region R is heated while being pressured by the projective portion of the nichrome wire heating tool 43, by which the release tapes 2 and 7 are joined together by local fusion or by local fusion and local deformation. Thus, the first ACF tape 1 and the second ACF tape 6 are joined together.

The release tape 2, 7 as in this case has a width of about 1 to 3 mm and a thickness of about 30 to 50 μm as an example. The nichrome wire heating tool 43, as shown in FIG. 5, is so formed that its heating wire width d1 is about 0.7 mm and its projective portion length d2 is about 5 mm.

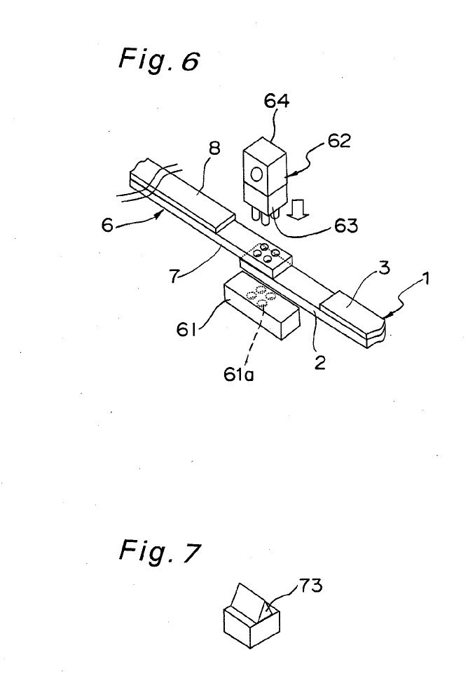

It is noted here that the heating unit 42 in the splicing unit 40 is not limited to such a mode in which the nichrome wire heating tool 43 is included, and other various modes may also be adopted. For example, as shown in the schematic explanatory view of FIG. 6, a heating unit 62 may include a projective tool 63 including a plurality of projective portions, e.g., four projective portions, and a heater 64 for heating the projective tool 63. Further, as shown in FIG. 7, a projective tool 73 including a wedge-shaped projective portion may also be used. Furthermore, instead of the formation that the surface on which the ACF tape is to be placed is a flat surface as in the stage 41, a stage 61 may include recess portions 61a matching the projective form of the projective tool 63, as shown in FIG. 6.

Next described is a mode of thermal fusion bonding (or thermo-compression bonding), i.e., a junction of ACF tapes by fusion with the use of the splicing unit 40 having the above-described construction.

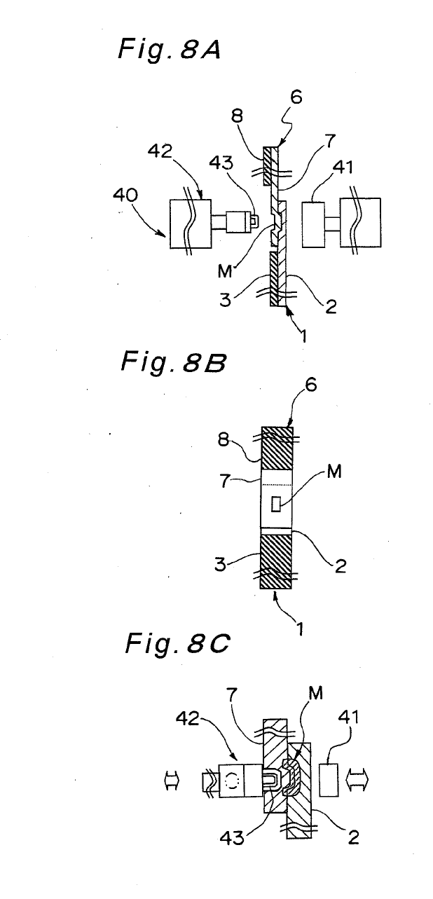

First, a case in which thermal fusion bonding is performed by using the nichrome wire heating tool 43 is explained with reference to the schematic explanatory views of FIGS. 8A to 8C. As shown in FIGS. 8A and 8C, part of the superposition region R of the first ACF tape 1 and the second ACF tape 6 placed on the stage 41 is pressured by the nichrome wire heating tool 43, resulting in a state that the release tapes 2, 7 are locally deformed to form a dent portion in the superposition region R. In this state, heating is performed by the nichrome wire heating tool 43, by which the release tapes 2, 7 are locally fused and bonded at the dent portion as shown in FIG. 8C with the result that the release tapes 2, 7 are joined together. In such a joined state, a local fusion-bonded portion (primary fusion-bonded portion) M is formed. Also, as shown in FIG. 8B, such a local fusion-bonded portion M, having a planar shape longer in the longitudinal direction of the ACF tapes, is located partly (e.g., generally at a central portion) in the widthwise direction of the ACF tapes without extending over its entire width. It is noted that the release tapes 2, 7 are formed from a resin material such as PET (polyethylene terephthalate). Also, a heating temperature by the nichrome wire heating tool 43 is set to a temperature within a range from a thermal deformation point to a melting point of the release tape, e.g., to 85° C., and the heating time is set to 1 sec. In addition, although the heating temperature is set here to a temperature within a range from the thermal deformation point to the melting point of the release tape, yet the heating may also be done up to temperatures beyond the melting point and below a thermal decomposition starting temperature of the release tape as far as the temperatures fall within a range that does not cause tape damage or adverse effects on tape feed in the local fusion bonding of the release tape.

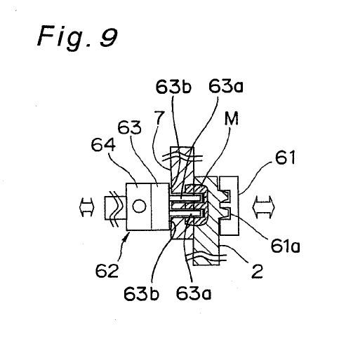

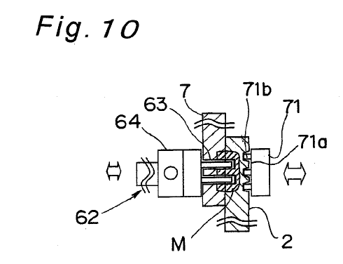

Next, a case in which thermal fusion bonding is performed by using the projective tool 63 including a plurality of projective portions is explained with reference to the schematic explanatory view of FIG. 9. As shown in FIG. 9, a plurality of recess portions 61a corresponding to the configuration of the individual projective portions of the projective tool 63 are formed in the stage 61. Therefore, part of the superposition region R of the first ACF tape 1 and the second ACF tape 6 is pressured by the projective tool 63, resulting in a state that part of the release tape 2 in the first ACF tape 1 is inserted into the recess portions 61a of the stage 61. Such a state, when given, makes it possible to achieve a state that the individual projective portions of the projective tool 63 have reached deep inside the release tapes 2, 7, respectively. In this state, heating is performed by the heater 64, by which the local fusion-bonded portion M is formed.

Preferably, each of the projective portions of the projective tool 63 is so formed as to have a height size larger than a thickness of at least one tape, i.e., a thickness of the release tape 7. Such formation allows the forward end of each projective portion to bite also into the release tape 2 when the release tape 7 is pressed by the projective portion, so that a stronger junction can be achieved.

Also, preferably, the individual recess portions 61a formed in the stage 61 are so shaped that their inner surfaces for receiving the projective portions via tape are larger than the shape of the projective portions. With such a form adopted, tape releasability from the recess portions 61a after the tape junction can be bettered. From such a point of view, instead of the case that a plurality of recess portions 61a corresponding to a plurality of projective portions, respectively, are formed as shown in FIG. 9, one large recess portion capable of receiving a plurality of projective portions collectively may be formed.

Further, preferably, as shown in FIG. 9, the projective tool 63 is formed so as to include a plurality of projective portions 63a, and a flat portion 63b for holding the release tapes 2, 7 between the projective tool and the stage 61 by pressing the release tape 7 in vicinities of the press region against the stage 61 by the individual projective portions 63a. That is, during the pressing and heating of the release tapes 2, 7 by the projective portions 63a, it is preferable that the release tapes 2, 7 are pressed in the vicinities by the flat portion 63b so as to be firmly held. By such holding, the release tapes 2, 7 can be prevented from being largely deformed or dislocated during the pressing and heating, so that a reliable junction can be achieved.

Also in the ACF applying apparatus 100 of this embodiment, an ACF tape having a relatively small width is used. In such a case that an ACF tape having a relatively small width is used, it is preferable that in the projective tool 63, the plurality of projective portions 63a are arrayed (e.g., in one line) along the longitudinal direction of the release tapes 2, 7.

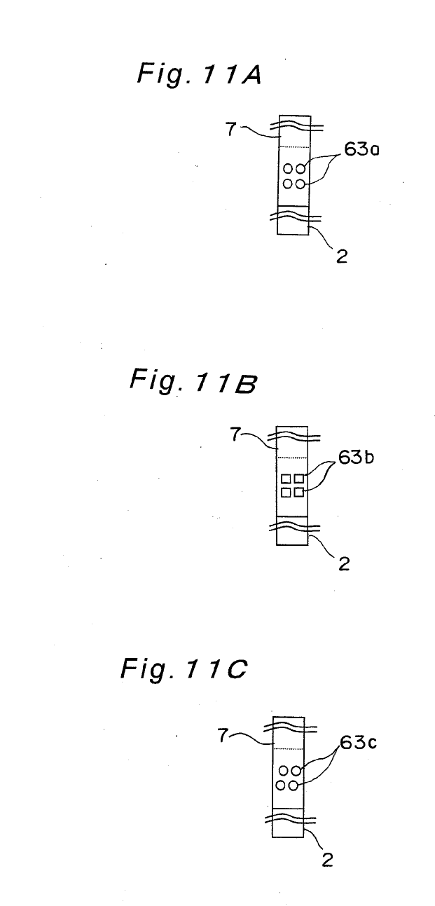

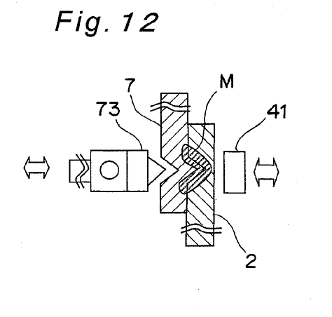

In addition, as shown in FIG. 10, in a stage 71, a plurality of bump portions 71b may be formed on its tape placement surface, by which recess portions 71a are formed. Otherwise, various forms may be adopted for shapes of the individual projective portions of the projective tool 63. For example, projective portions 63a having a circular planar shape as shown in FIG. 11A, projective portions 63b having a quadrilateral planar shape as shown in FIG. 11B, and a mode that projective portions 63c having a circular planar shape are so placed as to differ in arrangement between upper and lower rows as viewed in the figure, may also be adopted.

Besides, when thermal fusion bonding is performed by using the projective tool 73 having a wedge-shaped projective portion, the local fusion-bonded portion M locally formed in the superposition region R of each of the release tapes 2, 7 results in a shape corresponding to the wedge-shaped projective portion as shown in the schematic explanatory view of FIG. 12.

With the splicing unit having the construction described above, next described is a procedure for the splicing process of the first ACF tape and the second ACF tape. For the splicing unit 40, the following description is given on a case where a projective tool 73 having a wedge-shaped projective portion is provided as an example.

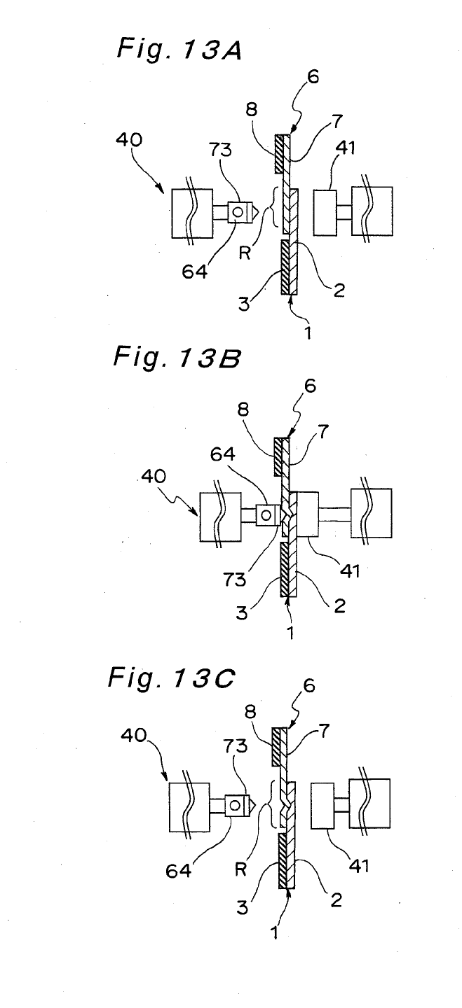

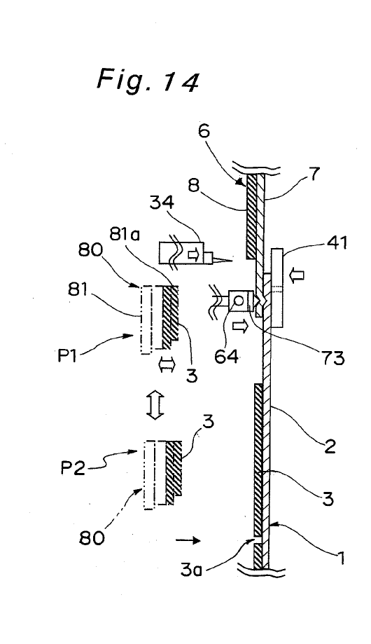

First, referring to FIG. 1, in the ACF feed unit 30, when a terminal end portion (e.g., a portion where a terminal end mark is provided at the terminal end of the ACF tape) of the in-use first ACF tape 1 is detected by the terminal-end detection sensor 33, the detection result is inputted to the control unit 9. In the control unit 9, in which a notification for requesting addition of an ACF tape is displayed, the in-use first ACF tape 1 and a newly added ACF tape 6 are positioned to a feed position that allows those ACF tapes to be set onto the stage 41 in the splicing unit 40 in such a fashion that the terminal end portion of the first ACF tape 1 and the leading end portion of the second ACF tape 6 are superimposed on each other, for example, by operator's manual work or by an unshown mechanical structure. The resulting state is the state shown in FIG. 13A.

Thereafter, as shown in FIG. 13B, in the splicing unit 40, the stage 41 is moved in a direction toward the superposition region R of the ACF tapes 1, 6, so that the superposition region R is set on the stage 41. Along with this, the projective tool 73 is moved in a direction toward the superposition region R so as to make contact with part of the superposition region R and moreover press and deform part of the superposition region R so that a dent portion is formed. The resulting state is the state shown in FIG. 13B.

Thereafter, the projective tool 73 is horizontal direction by the heater 64, by which the press portion in the superposition region R pressed by the projective tool 73 is fused. By this fusion, the release tape 2 of the first ACF tape 1 and the release tape 7 of the second ACF tape 6 are partly fusion-bonded in the superposition region R. Subsequently, as shown in FIG. 13C, the stage 41 and the projective tool 73 are separated from the ACF tapes 1, 6, thus the splicing process of ACF tapes being completed. After that, in the ACF applying apparatus 100, applying process of an ACF 3 to the panel substrate 4 is carried out by using the second ACF tape 6 connected to the first ACF tape 1.

According to this first embodiment, in the ACF applying apparatus 100, during the splicing process performed with the new second ACF tape 6 added to the in-use first ACF tape 1, the release tape 2 at the terminal end portion of the first ACF tape 1 and the release tape 7 at the leading end portion of the second ACF tape 6 are superimposed on each other, and in this superposition region R, tapes are heated while being locally pressured and thereby deformed, where the tapes are fusion-bonded at the pressured portions. Thus, the splicing process can be achieved.

Accordingly, the splicing process can be carried out without requiring preparations for additional junction members other than the ACF tape. Further, the device unit for performing such splicing process can be simplified in construction, its components being, for example, a projective tool 43, 63, 73, a heating means (heater 64 etc.) therefor, and a stage 41, 61. Thus, there is involved no any complication of the apparatus. Further, since the fusion bonding is fulfilled by forming the local fusion portion M without fusing the generally entire surface of the superposition region R, the splicing process can be carried out without causing any large deformation of the release tapes 2, 7 due to the fusion bonding. Therefore, the tape handling can be maintained successful even during the subsequent transfer process. Thus, in the ACF applying apparatus 100, an efficient splicing process can be realized.

### SECOND EMBODIMENT

The present invention is not limited to the foregoing embodiment, and may be carried out in other various modes. For example, the device construction for carrying out the splicing process in an ACF applying apparatus according to a second embodiment of the invention is shown in the schematic view of FIG. 14.

As shown in FIG. 14, the ACF applying apparatus of this second embodiment, although including a splicing unit 40 (equipped with a wedge-shaped projective tool 73) similar to that of the first embodiment, yet additionally has an ACF disposal-shot unit 80 in adjacency to and on a tape-transfer-direction downstream side of the splicing unit 40.

The ACF disposal-shot unit 80 is a unit for performing so-called “disposal shot process,” which is a process for applying, separating and removing the ACF 3 to be removed in the first ACF tape 1 by making use of its adhesion. For enhancement of the adhesion of disposal-shot ACF, the ACF disposal-shot unit 80 may include a heating means (not shown). More specifically, as shown in FIG. 14, the ACF disposal-shot unit 80 includes: a disposal shot unit 81 having an ACF disposal-shot surface positioned so as to face the stage 41 of the splicing unit 40; an unshown withdrawal moving means for moving the disposal shot unit 81 forward and backward between a disposal shot position P1 which is a position facing the stage 41 and a withdrawal position P2 which is a position prevented from interference with the heating unit equipped with the projective tool 73; and an unshown disposal-shot moving means for fulfilling movement of the disposal shot unit 81 to press the ACF tape placed on the stage 41 in the disposal shot position P1.

Also, as shown in FIG. 14, the stage 41 functions as a pedestal for use in forming a cutout 3a in the ACF 3 or cutting the release tape 2 by the cutter 34, and moreover as a pedestal of the disposal shot unit 81 for use in performing the disposal shot process.

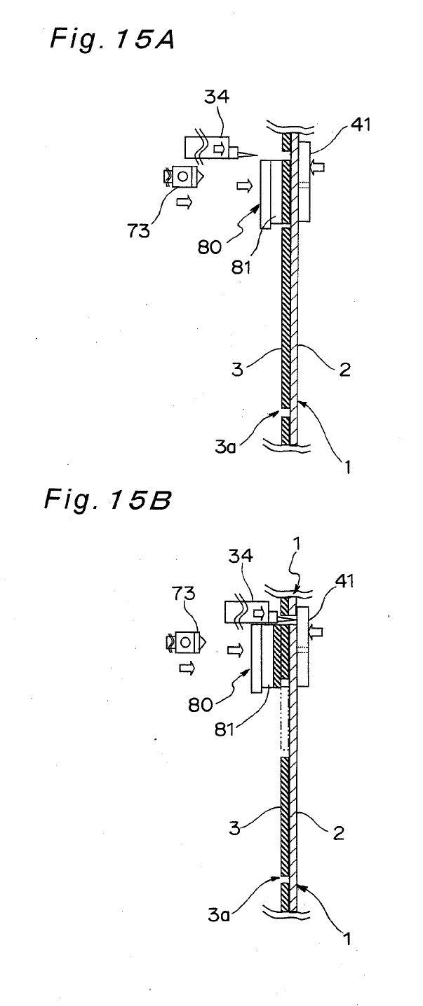

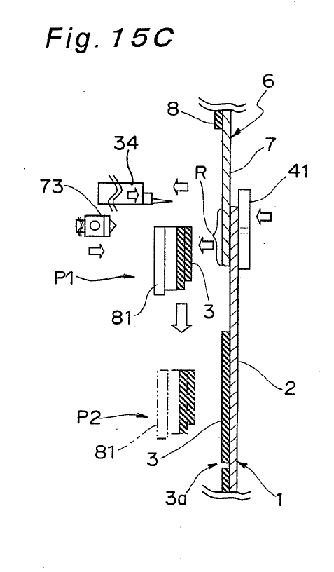

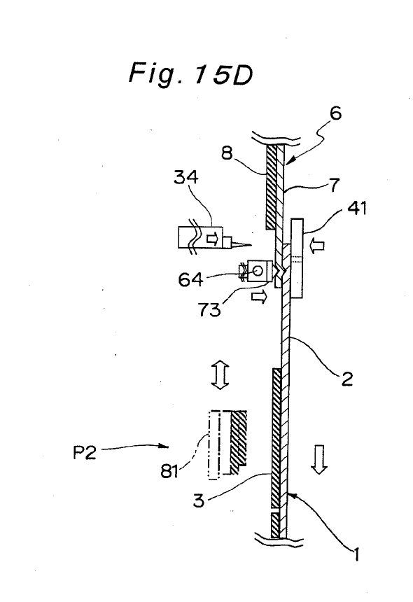

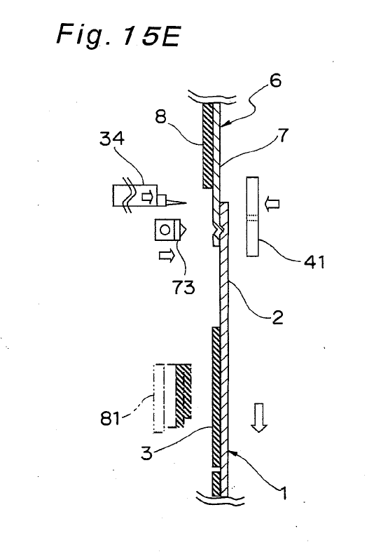

Next, with the unit construction shown above, a method for carrying out the splicing process associated with the disposal shot process is described with reference to the schematic explanatory views of FIGS. 15A to 15E. It is noted that the splicing process described below is to cut the in-use first ACF tape 1 at any arbitrary position and join the cutting position of the first ACF tape 1 taken as its terminal end portion with the leading end portion of the second ACF tape 6. Herein, the terminal end portion of the first ACF tape is assumed as including a cut end portion of an ACF tape that has been cut at an arbitrary position.

First, referring to FIG. 15A, the in-use first ACF tape 1 is set onto the stage 41 at a desired position (or arbitrary position). The arbitrary position in this case is a position in the first ACF tape 1 to which applied is an ACF piece 3 that is shorter than a length for applying to an ACF applying position of the panel substrate 4 as shown in FIG. 15A. In order that such an applying position of the ACF piece 3 and the disposal shot unit 81 are positioned, the first ACF tape 1 is set onto the stage 41. Then, the disposal shot unit 81 that has been positioned at the disposal shot position P1 is moved toward the stage 41 so that the ACF piece 3 is applied onto a disposal shot surface 81a. Thereafter, the disposal shot unit 81 is moved so as to go farther from the stage 41, by which the ACF piece 3 is separated and removed from the release tape 2.

Subsequently, by performing a feed operation of the first ACF tape 1, the first ACF tape 1 is set onto the stage 41 so that the applying position of an ACF piece 3 neighboring the removed ACF piece 3 and the disposal shot unit 81 are properly positioned. Next, as shown in FIG. 15B, the disposal shot unit 81 that has been positioned at the disposal shot position P1 is moved toward the stage 41, making the ACF piece 3 applied to the disposal shot surface 81a. Thereafter, the disposal shot unit 81 is moved so as to go farther from the stage 41, by which the ACF piece 3 is separated and removed from the release tape 2. Along with this, as shown in FIG. 15B, the cutter 34 is moved so as to approach the stage 41, so that the release tape 2 is cut off, thus a terminal end portion of the first ACF tape 1 being formed. In addition, in the first ACF tape 1, a tape member on the upstream side of the cutting position is removed.

Next, as shown in FIG. 15C, the leading end portion of the second ACF tape 6 is placed onto the stage 41, on which the terminal end portion of the first ACF tape 1 has been placed, so as to form the superposition region R. In this case, the terminal end portion of the first ACF tape 1, which has already been subjected to the disposal shot process of the ACF piece 3, is in a state that the ACF piece 3 has been removed from the release tape 2. The release tape 7 is placed so as to be superposed on the release tape 2. Along with this, the disposal shot unit 81 that has been positioned at the disposal shot position P1 is moved to the withdrawal position P2.

Thereafter, as shown in FIG. 15D, part of the superposition region R of the release tapes 2, 7 is simultaneously pressured and heated by the projective tool 73, by which junction of the release tapes 2, 7 to each other is achieved by fusion bonding. After that, as shown in FIG. 15E, the projective tool 73 is separated off, thus the splicing process being completed.

According to the splicing process of the second embodiment, the disposal shot process of the ACF piece 3 is carried out at an arbitrary position in the first ACF tape 1 during its use, and moreover the terminal end portion is formed by performing the cutting process of the release tape 2, thus making it possible to join the second ACF tape 6 to the terminal end portion of the first ACF tape 1 by local fusion bonding. Consequently, the degree of freedom in the splicing process can be improved, making it possible to fulfill efficient splicing process.

### THIRD EMBODIMENT

FIG. 16 shows a schematic showing a partial construction of an ACF applying apparatus 110 according to a third embodiment of the invention. As shown in FIG. 16, the ACF applying apparatus 110 of the third embodiment is so constructed that a heating unit 122 and a stage 121 are reverse placed with respect to the transfer path of the ACF tape in a splicing unit 120.

More specifically, as shown in FIG. 16, the stage 121 is placed between the cutter 34 and the ACF disposal-shot unit 80. Further, the heating unit 122 is placed so as to face the stage 121 with the ACF-tape transfer path interposed therebetween. The heating unit 122 is placed at a left-hand side portion in the head 21 of the pressure-bonding head unit 20 as in the figure, and is enabled to move so as to approach the stage 121 during pressuring and heating operations for the splicing process. In addition, the heating unit 122 includes a projective tool 123 and a heater 124. On the left side of the tape transfer path is placed a tape receiver stand 129 common to the cutter 34 and the ACF disposal-shot unit 80. In this tape receiver stand 129, an opening 129a is provided so that the projective tool 123 is enabled to pressure and heat the ACF tape during the splicing process. Therefore, interference between the projective tool 123 and the tape receiver stand 129 is prevented. Further, the tape receiver stand 129 has a function of sucking and holding the ACF tape, so that the ACF tape sucked and held by the tape receiver stand 129 is subjected to splicing process.

According to the construction of this third embodiment shown above, the heating unit 122 of the splicing unit 120 can be provided at a side portion of the head 21 of the pressure-bonding head unit 20, so that the apparatus construction can be further simplified. Also, the heating unit 122 provided in the head 21 may also be constructed so as to have a heater independent of a heater 23 of the head 21, in which case the projective tool 123 can be heating-controlled independently to a desired temperature, making it achievable to fulfill an optimum splicing process.

### FOURTH EMBODIMENT

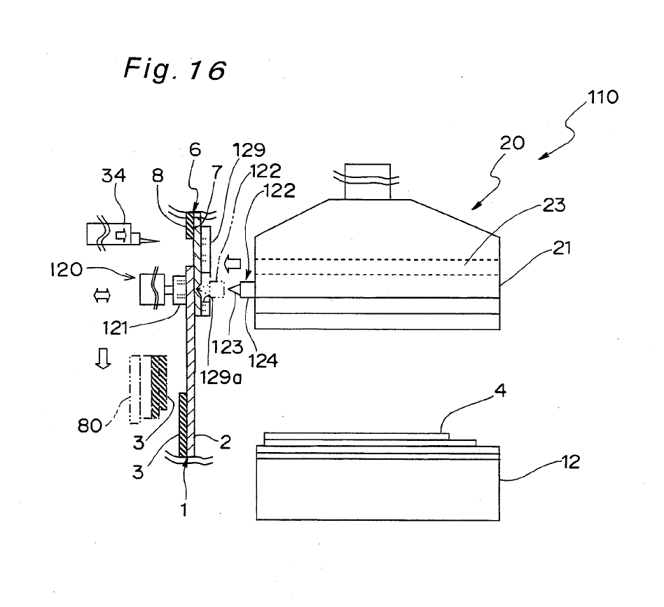

Next, FIG. 17 shows a schematic view showing a partial construction of an ACF applying apparatus 130 according to a fourth embodiment of the invention. As shown in FIG. 17, the ACF applying apparatus 130 of the fourth embodiment constructionally differs from that of the third embodiment in that a heating unit 142 included in a splicing unit 140 is fixedly provided at a side portion of the head 21 of the pressure-bonding head unit 20.

More specifically, a projective tool 143 included in the heating unit 142 is fixedly provided at a side portion of the head 21 as viewed in the figure. Also, the heating unit 142 includes no independent heater, while the heater 23 of the head 21 is provided so as to function as a heater for heating the projective tool 143. Further on the right side of the tape transfer path as viewed in the figure is provided a tape receiver stand 149 having a sucking function. In such a construction, the projective tool 143 cannot be moved so as to approach the stage 141. Therefore, the stage 141 is moved so as to approach the projective tool 143 so that the ACF tapes 1, 6 are moved rightward in the figure and sucked and held to the tape receiver stand 149, being subjected to the splicing process.

With the construction as shown above, the heater for heating the projective tool 143 can be used also as the heater 23 of the head 21, so that the apparatus construction can be further simplified.

### FIFTH EMBODIMENT

Next, FIG. 21 shows a schematic view showing a construction of an ACF applying apparatus 201 according to a fifth embodiment of the invention. It is noted that the same component members as in the foregoing embodiments are designated by the same reference signs with their description omitted and their differences will mainly be described below.

In this fifth embodiment, which differs from the foregoing embodiments principally in constructions of an ACF feed unit 207 and a release tape collection unit 209, it is contrived that a terminal end portion 1E of the first ACF tape 1 and a leading end portion 6S of the second ACF tape 6 can be automatically connected to each other so as to allow the ACF tapes 1, 6 to be continuously fed.

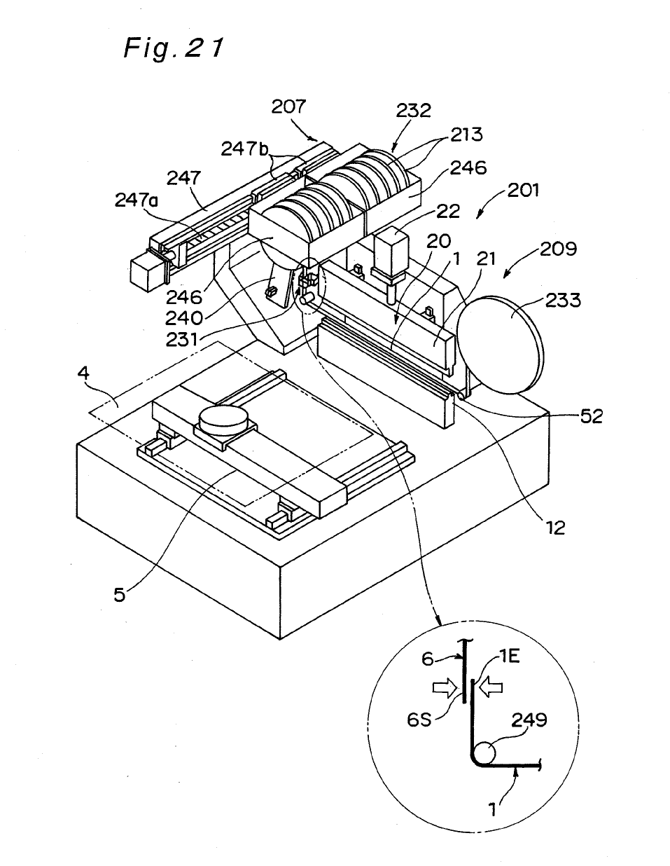

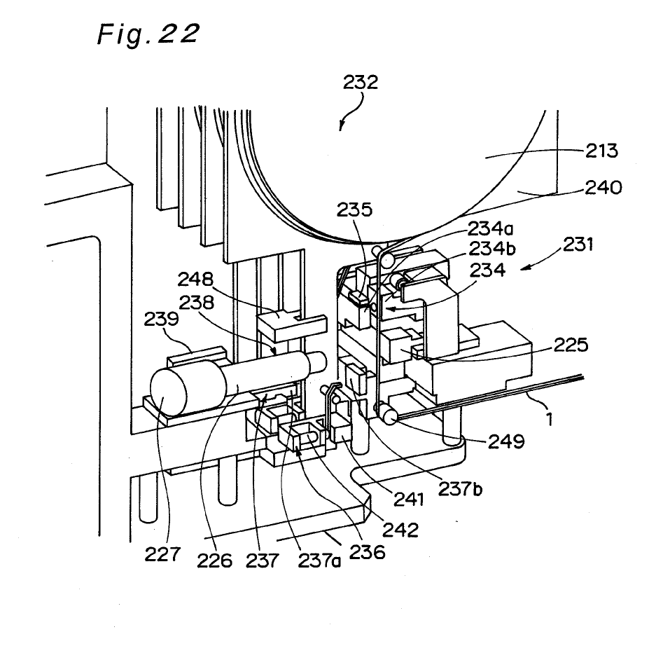

Referring to FIG. 21, the ACF feed unit 207 includes a splicing unit 231 (its detailed construction is shown in FIG. 22) for connecting the terminal end portion 1E of the first ACF tape 1 and the leading end portion 6S of the second ACF tape 6 to each other, and a reel feed part 232 for successively feeding a reel 213. The release tape collection unit 209 includes a winding part 233 for winding up the release tape 2 separated from the applied ACF and feeding the release tape 2 to a specified extent. In FIG. 21, which is a schematic perspective view of the ACF feed unit 207, a portion where the terminal end portion 1E of the first ACF tape 1 and the leading end portion 6S of the second ACF tape 6 are connected together at the splicing unit 231 is partly enlarged in illustration, and portions indicated by arrows in the figure are tape connecting portions.

The splicing unit 231, as shown in FIG. 22, includes a first holding part 234, a first cutting part 235, a second holding part 236, a second cutting part 237, and a thermo-compression bonding unit 238. In the ACF-tape transfer path, the thermo-compression bonding unit 238 is placed between the first holding part 234 and the second cutting part 237. The thermo-compression bonding unit 238 includes a stage 225, a heating unit 227 with a projective tool 226 fitted thereto, and a pressure unit 239 which makes the heating unit 227 moved toward the stage 225 to exert a specified pressing force thereon. In FIG. 22, reference sign 249 denotes a guide roller for guiding the ACF tape 1 to the pressure-bonding head unit 20.

The first holding part 234, which nips and holds the terminal end portion of the ACF tape 1 that has almost come to an end of use, has a pair of holding members 234a, 234b which can be operated so as to become closer to and farther from each other. The first cutting part 235 is placed at a top portion of the holding member 234a, i.e. on the upstream side of the holding member 234a in the ACF-tape transfer path, so as to cut the ACF tape 1 in association with the holding member 234b at the top position while nipping the ACF tape 1.

The second holding part 236 is placed at a bottom portion of a reel support plate 240 which rotatably holds the reel 213 having the ACF tape 6 wound thereon, so that between a holding base 241 and a cylinder unit 242 fitted to the holding base 241, the second holding part 236 nips the leading end portion of the ACF tape 6 drawn out from reel 213. The second cutting part 237, which is made up of a edge portion 237a provided in the pressure unit 239 and a receiving portion 237b, is so designed that generally simultaneously when or after the terminal end portion 1E of the in-use ACF tape 1 and the leading end portion 6S of the ACF tape 6 drawn out from a new reel 213 are connected together by the thermo-compression bonding unit 238, the second cutting part 237 cuts one side of the ACF tape 6 ranging from the connecting portion toward the second holding part 236.

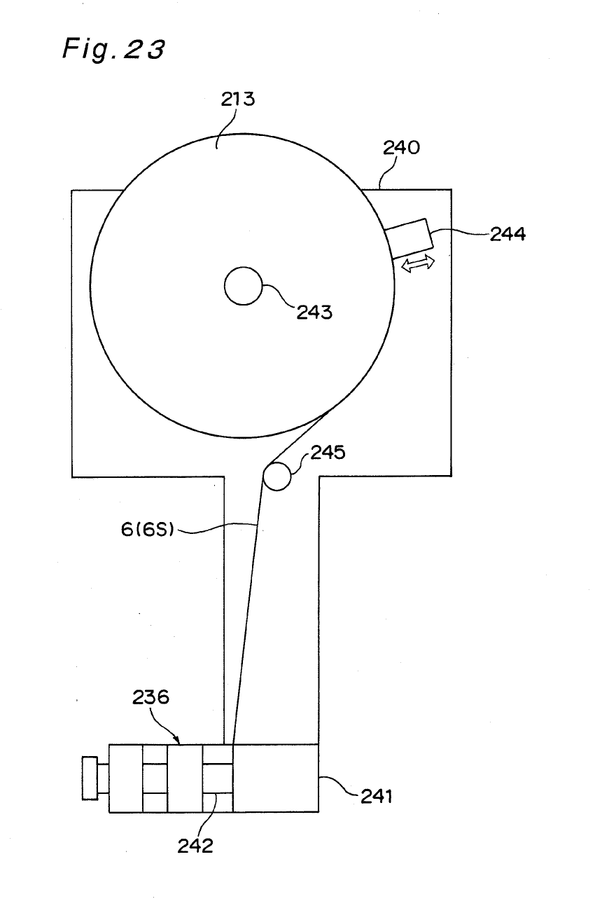

The reel support plate 240, as shown in FIG. 23, includes: a pivotal support portion 243 which is generally T-shaped as a whole and under which the second holding part 236 is placed and which rotatably supports the reel 213 above; an engagement portion 244 which is brought into pressure contact with and separation from an outer circumference of the reel 213 to serve for engagement or disengagement of rotation of the reel 213; and a guide roller 245 for guiding the ACF tape 6 from the reel 213 to the second holding part 236. The leading end portion 6S of the ACF tape 6 that has been drawn out from the reel 213 with its forward end held by the second holding part 236 is held in a tensile state by the engagement portion 244.

The reel feed part 232, as shown in FIGS. 21 and 22, include two movable holding parts 246 capable of removably holding a plurality of reel support plates 240 arrayed in parallel so that while the ACF tape 1 or 6 is being fed from the reel 213 held on one movable holding part 246, the other movable holding part 246 can be removed so as to allow replacement work of the reel support plates 240 to be carried out. Each of the movable holding part 246, which is movable and positionable by a moving unit 247, can make a held arbitrary reel support plate 240 positioned to a position facing the splicing unit 231. The moving unit 247 is so designed as to removably fit the movable holding part 246 to a mover 247b which is moved by a feed screw mechanism using ball screws 247a. Also provided is, as shown in FIG. 22, a fixing member 248 for fixing the reel support plates 240 positioned at positions facing the splicing unit 231.

Next, in the ACF applying apparatus 201 constructed as shown above, operation steps for, upon detection of the terminal end portion 1E of the first ACF tape 1 fed from the in-use reel 213, replacing the reel 213 with a new reel 213, and connecting the leading end portion 6S of the second ACF tape 6 drawn out from the reel 213 and the terminal end portion 1E of the first ACF tape 1 to each other by thermo-compression bonding are explained with reference mainly to FIG. 22 and FIGS. 24A to 26K.

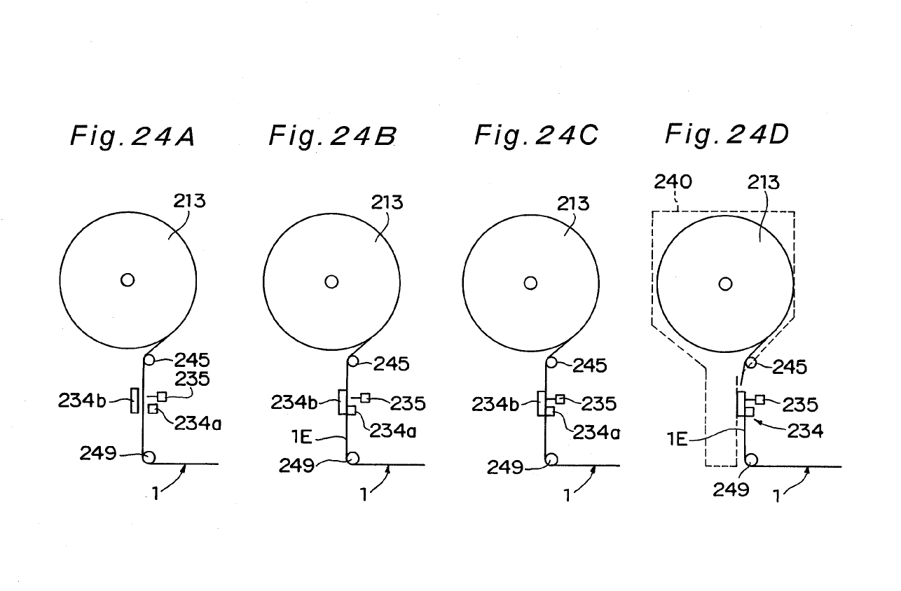

As shown in FIG. 24A, under the state that the first ACF tape 1 is being fed from the in-use reel 213 and applied to the substrate one after another, when a terminal end portion of the ACF is detected, the terminal end portion 1E of the first ACF tape 1 is held by the holding members 234a, 234b of the first holding part 234 as shown in FIG. 24B, and then the first ACF tape 1 is cut at an upper position, i.e. an upstream-side position in the transfer path, of the terminal end portion 1E by the first cutting part 235 as shown in FIG. 24C, by which the terminal end portion 1E is formed.

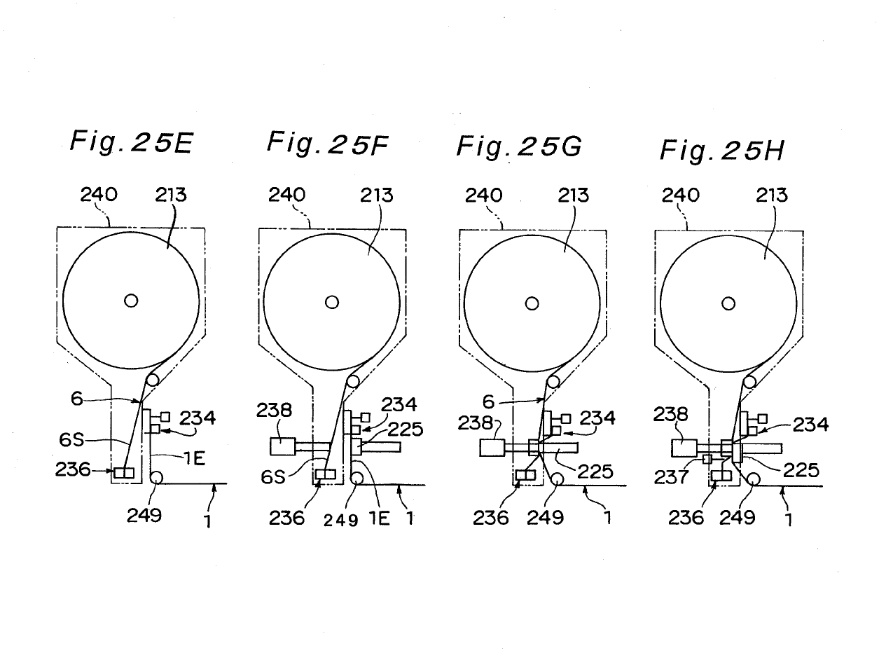

Next, the movable holding part 246 is operated so that a reel support plate 240 that has been supported the in-use reel 213 is withdrawn from the splicing unit 231 and a succeeding reel support plate 240 is positioned and fixed to a position facing the splicing unit 231 as shown in FIGS. 24D and 25E. Thereafter, the leading end portion 6S of the second ACF tape 6 drawn out from the new reel 213 is placed so as to be spliced on the terminal end portion 1E of the first ACF tape 1.

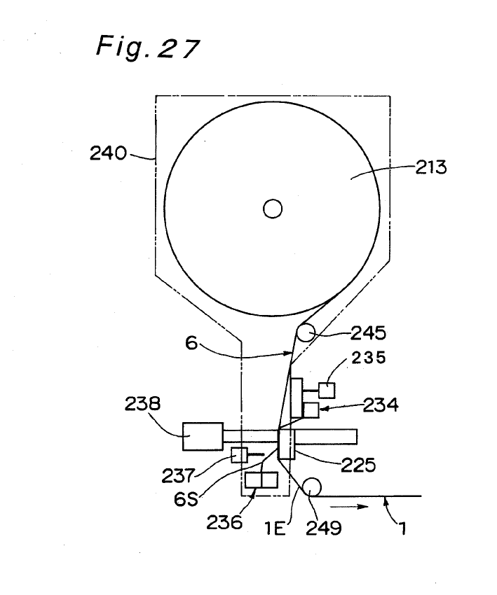

Next, as shown in FIGS. 25F, 25G and 27, the leading end portion 6S of the second ACF tape 6 and the terminal end portion 1E of the first ACF tape 1 that have been positioned so as to be spliced on each other are supported from their back faces by the stage 225 and, in this state, joined together by thermo-compression bonding by the thermo-compression bonding unit 238. More specifically, the leading end portion 6S of the second ACF tape 6 and the terminal end portion 1E of the first ACF tape 1, while pressed in the tape thicknesswise direction, are heated by using the projective tool 226 having a plurality of projective portions provided on its forward end face, so that the plurality of projective portions bite into the two tapes in their thicknesswise direction, making thermal energy concentratedly applied to the tapes. As a result, the ACF tapes 1, 6 are fused and joined together.

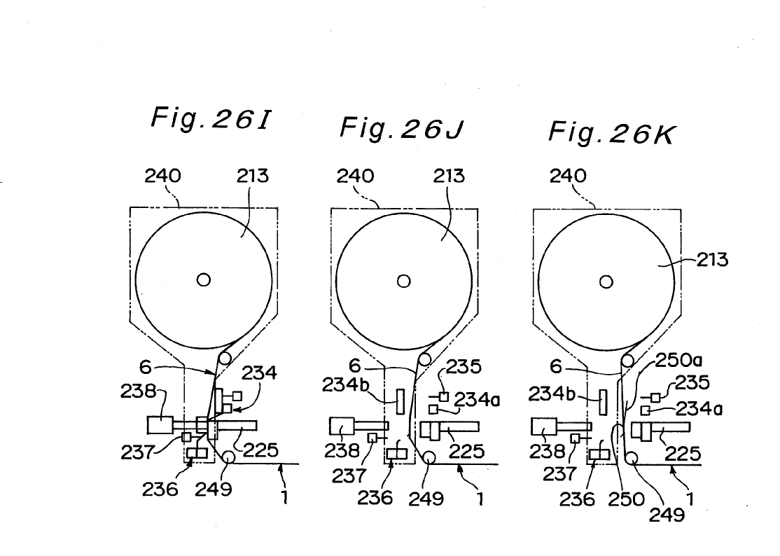

Next, as shown in FIGS. 25H and 26I, at a position between the junction positions of the ACF tapes 1 and 6 and their holding positions by the second holding part 236, the leading end portion 6S of the second ACF tape 6 is cut off by the second cutting part 237. Also, as shown in FIGS. 26I and 26K, holding of the terminal end portion 1E of the first ACF tape 1 is released by the holding members 234a, 234b of the first holding part 234, and the thermo-compression bonding unit 238 and the stage 225 are operated so as to be withdrawn. As a result, the first ACF tape 1 and the second ACF tape 6 are automatically connected to each other and fed continuously to the pressure-bonding head unit 20. When the above connecting operation is performed, the tape feed amount is so set and controlled that a tape connecting portion 250 is allowed to completely pass the junction position without staying at the junction position (pressure-bonding position).

In the state shown in FIG. 26K, with the first ACF tape 1 and the second ACF tape 6 connected together, the second ACF tape 6, as it is, is fed to the pressure-bonding head unit 20. In addition, since a portion from the tape connecting portion 250 to an edge portion of the first ACF tape 1 held by the first holding part 234 becomes a free end portion 250a without being joined with the second ACF tape 6, there is a fear that feed one another of the second ACF tape 6 in the subsequent steps is not performed smoothly, causing trouble or the like. For suppression of such trouble, an edge processing step described below is preferably performed additionally.

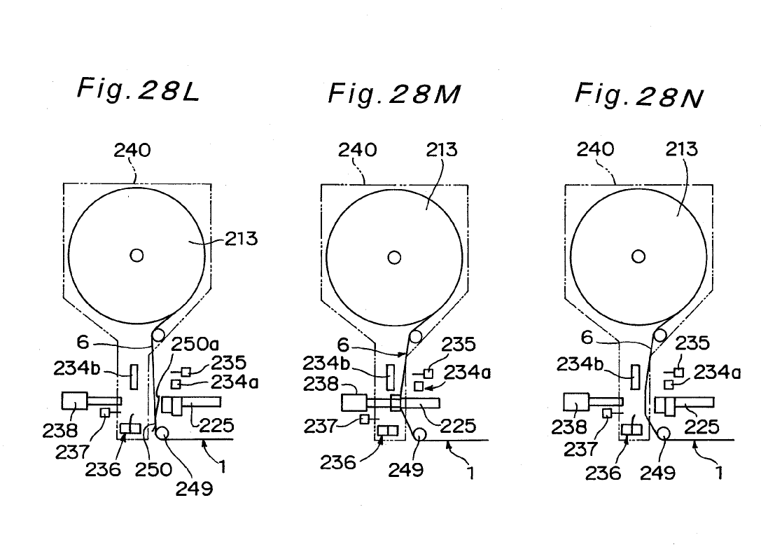

More specifically, as shown in FIGS. 26K and 28L, the ACF tape 6 is moved so that the free end portion 250a of the terminal end portion 1E of the first ACF tape 1 is positioned between the thermo-compression bonding unit 238 and the stage 225. Next, as shown in FIG. 28M, a the thermo-compression bonding unit 238 is pressed against the second ACF tape 6 again, and thermal energy is applied by the thermo-compression bonding unit 238 to perform an edge fusion-bonding step for fusion bonding of the free end portion 250a of the terminal end portion 1E of the first ACF tape 1 to the second ACF tape 6. Thereafter, as shown in FIG. 28N, the thermo-compression bonding unit 238 and the stage 225 are operated so as to be withdrawn, and the first ACF tape 1 and the second ACF tape 6 connected to each other are continuously fed to the pressure-bonding head unit 20.

As shown above, at least in addition to the tape connecting portion 250 between the terminal end portion 1E of the first ACF tape 1 and the leading end portion 6S of the second ACF tape 6, the free end portion 250a of the terminal end portion 1E of the first ACF tape 1 positioned on the upstream side of the tape connecting portion 250 in the ACF-tape transfer path is fusion-bonded to the second ACF tape 6, so that the feed operation of the ACF tapes 1, 6 after their junction can be made smoothly achievable. Thus, the fear for occurrence of trouble can be solved. In addition, although the edge process may similarly be performed also for the leading end portion 6S of the second ACF tape 6, a cutting site of the leading end portion 6S after the connection can be set to a vicinity of the tape connecting portion 250 so that the edge portion becomes shorter in length and is on the outer-surface side free from contact with rollers or the like primarily constituting the feed path of the ACF tape 6, thus it being not necessarily required to do the edge process.

(Structure of ACF Tape to be Spliced)

Here are explained structures at junction portions of ACF tapes to which the splicing process in the foregoing individual embodiments can be applied.

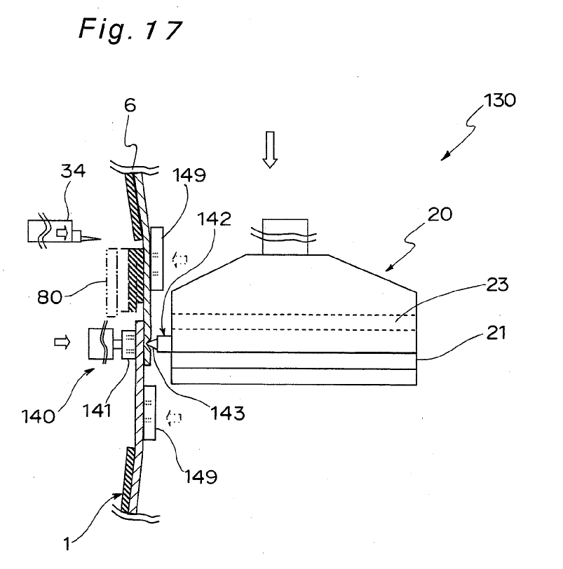

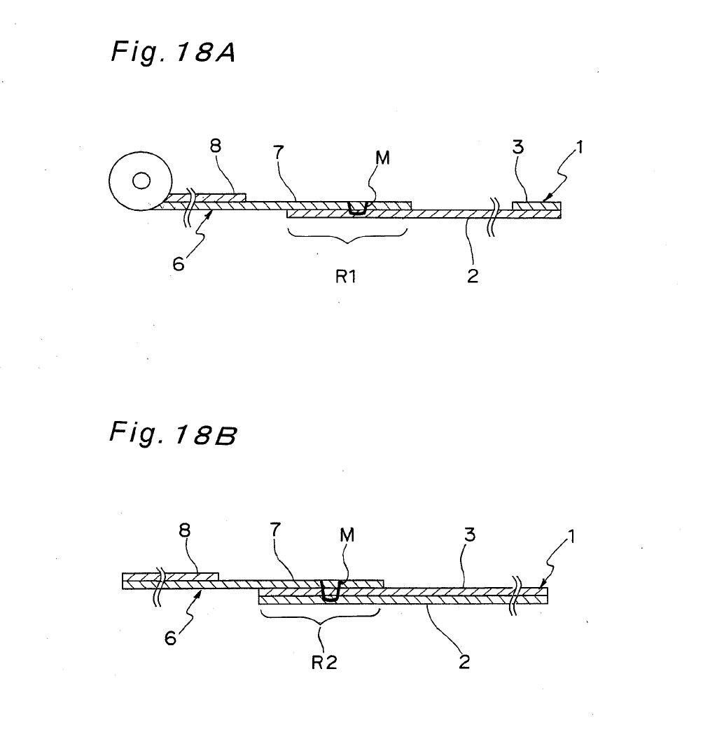

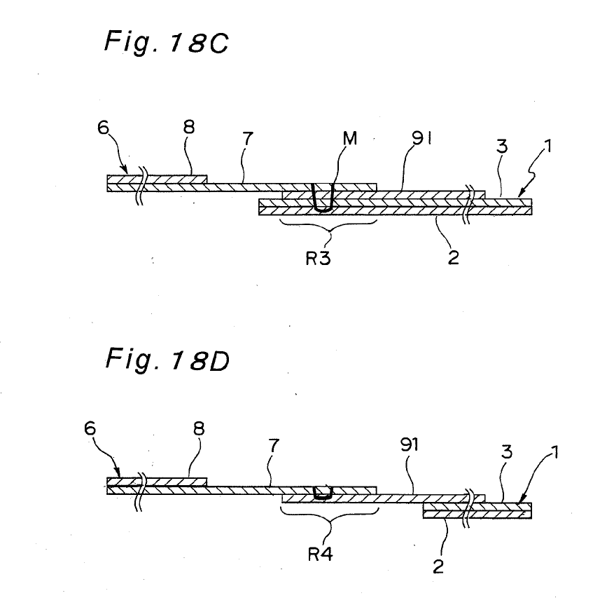

First, the structure of a junction position of ACF tape shown in FIG. 18A is one that has been described hereinabove. That is, a terminal end portion of the release tape 2 where no ACF 3 is placed in the first ACF tape 1, and a leading end portion of the release tape 7 where no ACF 8 is placed in the second ACF tape 6, are superimposed on each other in the thicknesswise direction, by which a superposition region R1 is formed. Junction by fusion bonding is performed for this superposition region R1.

Next, with regard to the structure shown in FIG. 18B, at the terminal end portion of the first ACF tape 1, the ACF 3 is present on the release tape 2, and the leading end portion of the release tape 7 in the second ACF tape 6 is superimposed thereon via the ACF 3, by which a superposition region R2 is formed. Thus, even with the ACF present therebetween, the release tapes 2, 7 can be fusion-bonded and joined together by pressurization and heating with the projective tool with the ACF 3 pushed aside, making it possible to apply the splicing process of the invention.

Next, in the structure shown in FIG. 18C, a terminal-end mark tape 91 visually showing a terminal end is provided at a terminal end portion of the first ACF tape 1, in addition to the structure of FIG. 18B. That is, the release tape 2 in the first ACF tape 1, the ACF 3, the terminal-end mark tape 91, and the release tape 7 in the second ACF tape 6 are provided in a superposition region R3. The terminal-end mark tape 91, which is made, for example, from a material similar to that of the release tape, is capable of, even when used for the junction, obtaining enough bond strength by being locally pressured and heated by the projective tool of the invention. In this case, by being pressured and heated by the projective tool, the release tapes 2, 7 and the terminal-end mark tape 91 can be fusion-bonded so as to push the ACF 3 aside. In addition, in such a case where the terminal-end mark tape 91 is placed on the first ACF tape 1 as shown above, the disposal shot operation for removing the ACF 3 at the terminal end portion can be made unnecessary.

Also, with use of such a terminal-end mark tape 91 as shown above, as shown in FIG. 18D, it is also allowable that with the terminal end portion of the first ACF tape 1 given only by the terminal-end mark tape 91, the terminal-end mark tape 91 and the release tape 7 of the second ACF tape 6, by which a superposition region R4 is formed, are joining together by fusion bonding.

In addition, FIG. 18E is a view showing one example of a conventional splicing structure. In the conventional structure, as shown in FIG. 18E, a terminal-end mark tape 91 placed at the terminal end portion of the first ACF tape 1 and the release tape 7 of the second ACF tape 6 are joining together by adhesion via a double-sided tape 92, which is an additional member. The double-sided tape 92 having a length of about 10 mm is used, and the terminal-end mark tape 91 having a length of 60 mm is used. In such a conventional structure, the double-sided tape 92 that is an additional member is necessitated, and moreover the device construction for applying of the double-sided tape 92 is complicated and a management burden therefor is increased, problematically.

However, in the splicing processes of the foregoing individual embodiments, the junction can be achieved by locally fusion-bonding the superposition region by the projective tool without using any additional member such as double-sided tape. Accordingly, the problems of the prior art can be solved, so that an efficient splicing process can be realized.

(Component Mounting Process)

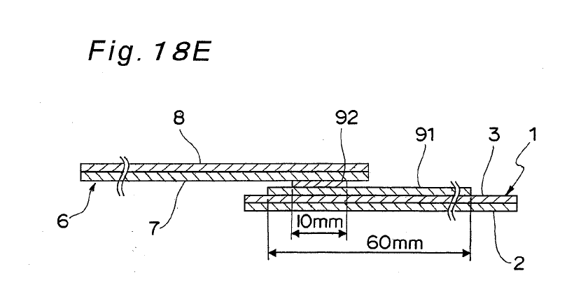

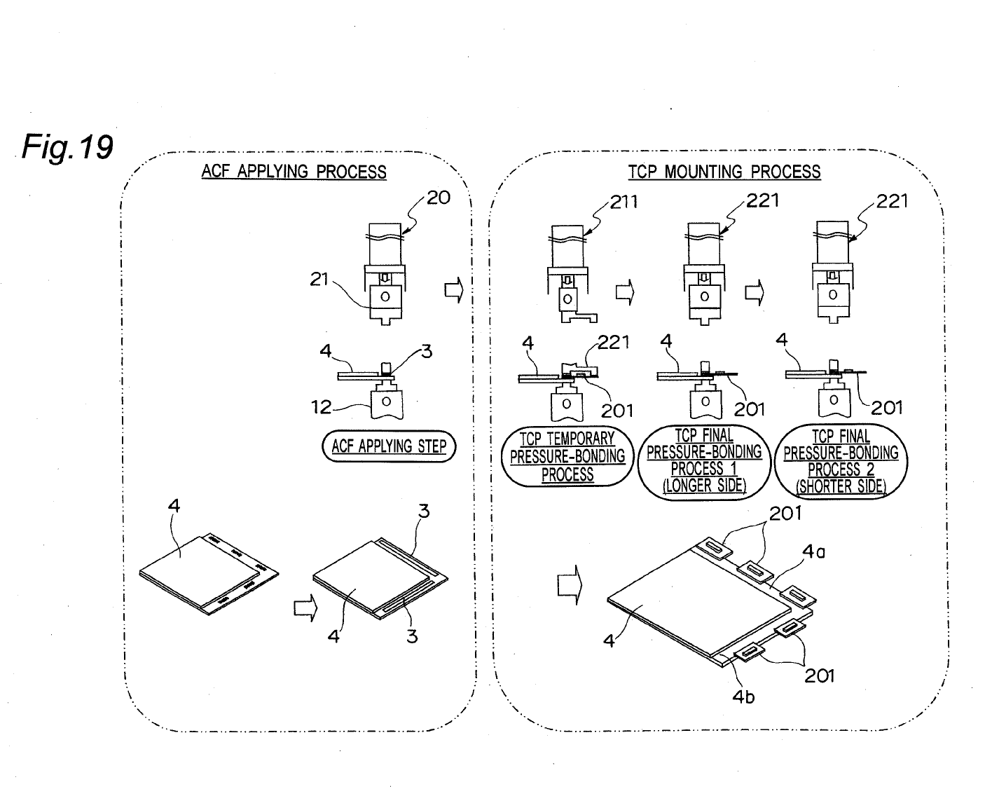

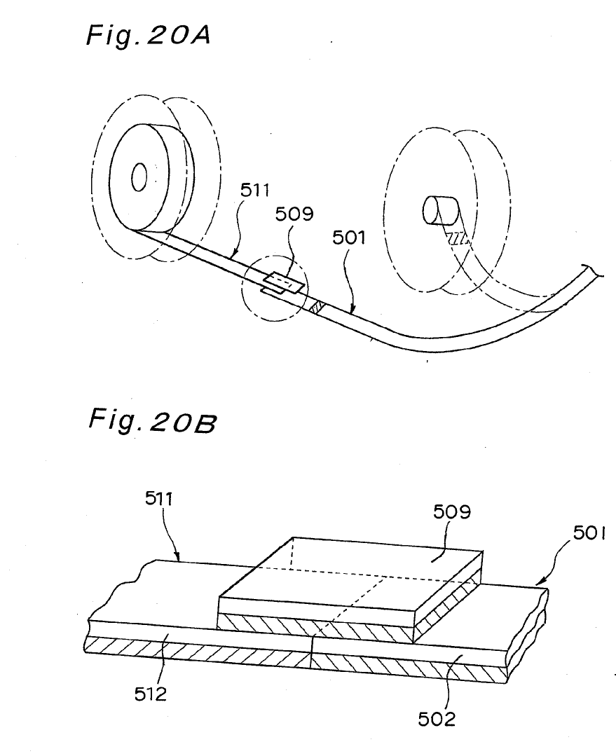

Next, a component mounting process in which TCPs are mounted as components onto the panel substrate 4 by using ACF applying apparatuses (e.g., ACF applying apparatus 100) of the foregoing individual embodiments is explained with reference to the conceptual view shown in FIG. 19.

As shown in FIG. 19, the component mounting process is divided roughly into an ACF applying step for applying the ACF piece 3 to the panel substrate 4, and a TCP mounting process for mounting TCPs onto the panel substrate 4 via the ACF piece 3.

The ACF applying process is as described above. The TCP mounting process can be further divided into three processes of a TCP temporary pressure-bonding process, a TCP final pressure-bonding process (for longer side) and a TCP final pressure-bonding process (for shorter side).

The TCP temporary pressure-bonding process is a step for temporarily pressure bonding a TCP 201 with use of a head 211 via the ACF piece 3 applied to the panel substrate 4. The TCP final pressure-bonding process is a step for pressuring and heating of the TCP 201, which has been temporarily pressure-bonded via the ACF 3, by a head 221 so that the ACF 3 is cured to achieve mounting. Since a longer-side terminal portion (source-side terminal portion) and a shorter-side terminal portion (gate-side terminal portion) are provided on the panel substrate 4, the final pressure-bonding process is carried out for each of the terminal portions.

The individual steps as shown above are continuously carried out by side-by-side placement of the ACF applying apparatus 100, a TCP temporary pressure-bonding apparatus and a TCP final pressure-bonding apparatus and by forming a sequential transfer path passing through the individual working apparatuses.

In the TCP final pressure-bonding process, a protective tape as an example of the tape member is used between the pressure bonding surface of the head 221 and the panel substrate 4 so that the molten ACF 3 is prevented from coming out and applying to the pressure bonding surface of the head 221. Such a protective tape is fed by a reel, and it is set up that the protective tape that has been used once or a specified times of pressure bonding is wound up and moreover a new protective tape is fed from a reel. This protective tape is made from resin material. Therefore, the splicing processes of the invention are applicable also to such a protective tape. That is, a terminal end portion of an in-use first protective tape and a leading end portion of a newly added second protective tape are superimposed on each other and then fusion bonded partly at their superposition region, by which those protective tapes can be joined together. Since such a splicing process being applicable also to the protective tape in the final pressure-bonding process, it becomes achievable to improve the productivity of the component mounting process as a whole. It is noted that such a protective tape is formed from a resin material such as Teflon (registered trademark in Japan) or silicon.

The foregoing individual embodiments have been described on constructions of the splicing unit in which thermal fusion is fulfilled with use of thermal energy by a heater or nichrome wire. However, the present invention is not limited to such a case only. Instead of such cases, for example, ultrasonic energy may also be used as the energy. With an ultrasonic tool provided on the splicing unit, while the ultrasonic tool is kept in contact with the superposition region R, applying ultrasonic energy thereto allows the tapes to be fused and joined together. In a case where a ultrasonic tool using ultrasonic energy is adopted as in this case, it is preferable that a plurality of projective portions are formed in the ultrasonic tool and moreover each of the projective portions is formed at a height larger than a thickness of at least one release tape. With use of such an ultrasonic tool, ultrasonic energy can be effectively concentrated to achieve local junction of release tapes to each other. Accordingly, for the present invention, nichrome wire, heater and such ultrasonic energy applying means as shown above are an example of the energy applying device.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2007-091962 filed on Mar. 30, 2007, including specification, claims, and drawings are incorporated herein by reference in its entirety.

1. A working apparatus for transferring, along a tape transfer path, a tape member formed at a width of 1 to 3 mm from resin material, and working for mounting of components onto a substrate by using the tape member, the working apparatus comprising:
a stage on which a terminal end portion of an in-use first tape member and a leading end portion of a newly added second tape member are placed so as to be superimposed on each other in their thicknesswise direction; and
a tape junction device including: a projective portion which is placed so as to face the stage and which pressures a superposition region of end portions of the first and second tape members on the stage at least partly in a widthwise direction of the tape members to form a dent portion in the superposition region; and an energy applying device for applying energy to the projective portion, wherein the tape junction device, while pressuring the tape members by the projective portion so as to form a dent portion in the superposition region, applies energy to the projective portion from the energy applying device so as to heat the tape members so that the terminal end portion of the first tape member and the leading end portion of the second tape member are partly fused at their superposition regions so as to be joined together.

2. An apparatus for applying adhesive tape for transferring, along a tape transfer path, a tape member of a 1 to 3 mm width with an adhesive tape applied on one side of a release tape, cutting the adhesive tape into a specified length, peeling the adhesive tape from the release tape, and applying the adhesive tape to a substrate, the apparatus for applying adhesive tape comprising:
a stage on which a terminal end portion of an in-use first tape member and a leading end portion of a newly added second tape member are placed so as to be superimposed on each other in their thicknesswise direction;
a tape junction device including: a projective portion which is placed so as to face the stage and which pressures a superposition region of end portions of the first and second tape members on the stage at least partly in a widthwise direction of the tape members to form a dent portion in the superposition region; and an energy applying device for applying energy to the projective portion, wherein the tape junction device, while pressuring the tape members by the projective portion so as to form a dent portion in the superposition region, applies energy to the projective portion from the energy applying device so as to heat the tape members so that the terminal end portion of the first tape member and the leading end portion of the second tape member are partly fused at their superposition regions so as to be joined together.

3. The apparatus for applying adhesive tape as defined in claim 2, wherein the tape junction device has, as the energy applying device, a heating unit for heating the projective portion so as to allow the terminal end portion of the first tape member and the leading end portion of the second tape member to be thermally fused and joined together.

4. The apparatus for applying adhesive tape as defined in claim 3, wherein the projective portion has a height larger than a thickness of the tape members.

5. The apparatus for applying adhesive tape as defined in claim 3, wherein the tape junction device includes a plurality of the projective portions so that the superposition region of the first and second tape members is pressed by the individual projective portions.

6. The apparatus for applying adhesive tape as defined in claim 3, wherein a recess portion for receiving the projective portion by an inner surface of the recess portion via the tape members is formed in the stage.

7. The tape applying apparatus as defined in claim 6, wherein the inner surface of the recess portion is formed larger than the projective portion.

8. The tape applying apparatus as defined in claim 3, wherein in the tape junction device, the projective portion is provided so as to make contact with a widthwise central portion of the tape members placed on the stage.

9. The tape applying apparatus as defined in claim 3, wherein the tape junction device includes a tool having the projective portion, and a flat portion for pressing, against the stage, a peripheral region of a press region of the tape members pressed by the projective portion to hold the superposition region of the tape members.

10. The tape applying apparatus as defined in claim 3, wherein the projective portion is formed of a heating wire, and the heating unit supplies electric power to the heating wire.

11. The tape applying apparatus as defined in claim 3, wherein the tape junction device joins together the release tape of the first tape member and the release tape of the second tape member by thermal fusion bonding.

12. The apparatus for applying adhesive tape as defined in claim 3, wherein the first tape member and the second tape member are held wound on reels, respectively, and fed from their reproductive reels, and wherein
the tape junction device comprises:
a first holding member which is placed on a more upstream side than a junction position of the projective portion in the tape transfer path and which holds the first tape member drawn out from the reel;
a first cutting part which is placed on a more upstream side than a holding position of the first holding member in the tape transfer path and which cuts the first tape member held by the first holding member to form the terminal end portion of the first tape member;
a second holding member which is placed on a more downstream side than the junction position of the projective portion in the tape transfer path and which holds the leading end portion of the second tape member drawn out from the reel; and
a second cutting part which is placed between a holding position of the second holding member and a junction position of the projective portion in the tape transfer path and which cuts the second tape member on the downstream side of the junction position.

13. A tape member adding method for adding a tape member to an apparatus for applying adhesive tape which works for transferring, along a tape transfer path, a tape member of a 1 to 3 mm width with an adhesive tape applied on one side of a release tape, cutting the adhesive tape into a specified length, peeling the adhesive tape from the release tape, and applying the adhesive tape to a substrate, the tape member adding method comprising:
placing a terminal end portion of an in-use first tape member and a leading end portion of a newly added second tape member in superimposition on each other in their thicknesswise direction by the apparatus for applying adhesive tape; and
pressuring a superposition region of end portions of the first and second tape members at least partly in a widthwise direction of the tape members to form a dent portion in the superposition region, and heating the dent portion to partly fuse and join together the terminal end portion of the first tape member and the leading end portion of the second tape member at their superposition regions.

14. The tape member adding method as defined in claim 13, wherein in the junction of the tape members, the release tape in the first tape member and the release tape of the second tape member are joining together by thermal fusion bonding.

15. The tape member adding method as defined in claim 13, wherein after the adhesive tape applied to the terminal end portion of the first tape member is removed, the first and second tape members are placed so as to be superimposed on each other.

16. The tape member adding method as defined in claim 13, wherein the first tape member and the second tape member are held wound on reels, respectively, and fed from their reproductive reels, and wherein
the first tape member placed on the tape transfer path is held on a more upstream side than a junction position with the second tape member, the first tape member is cut off on a more upstream sick than the holding position to form the terminal end portion, then with the second tape member fed from the reel along the tape transfer path, the leading end portion of the second tape member is held on a more downstream side than the junction position on the tape transfer path, and the terminal end portion of the first tape member and the leading end portion of the second tape member are placed at the junction position so as to be superimposed to each other in their thicknesswise direction by holding the leading end portion of the second tape member on a more downstream side than the junction position in the tape transfer path, and
simultaneously when or after the first tape member and the second tape member are joined together at the junction position, the second tape member is cut off at a position between the junction position and the holding position of the leading end portion of the second tape member.

17. The apparatus for applying adhesive tape as defined in claim 12, further comprising
a control unit which executes: a junction process in which while the terminal end portion of the first tape member held by the first holding member and the leading end portion of the second tape member held by the second holding member are placed so as to be superimposed on each other on the stage, the tape junction device is controlled so that the tape members placed so as to be superimposed on each other are pressed by the projective portion, and moreover energy is applied to the projective portion by the energy applying device, whereby the terminal end portion of the first tape member and the leading end portion of the second tape member are partly fused and joined together at the superposition region; and
an edge fusion-bonding process in which with the holding of the terminal end portion of the first tape member by the first holding member released after execution of the junction process, the tape members are moved so that at least an edge portion of the terminal end portion of the first tape member is positioned between the projective portion and the stage, and the tape junction device is controlled once again so that the edge portion of the terminal end portion of the first tape member is pressed by the projective portion, and moreover energy is applied to the projective portion by the energy applying device, whereby the edge portion of the terminal end portion of the first tape member is fused and joined with the leading end portion of the second tape member.

18. The tape member adding method as defined in claim 16, wherein
the holding of the terminal end portion of the first tape member is released after the terminal end portion of the first tape member and the leading end portion of the second tape member are partly fused and joining together at the superposition region, and
thereafter, while the superposition region between the edge portion of the terminal end portion of the first tape member and the second tape member is pressured and heated simultaneously, whereby the edge portion of the terminal end portion of the first tape member and the second tape member are fused and joined together at the superposition region.
